(19) United States
(12) Patent Application Publication
(10) Pub. No.: US 2016/0026927 A1
(43) Pub. Date: Jan. 28, 2016

(54) BAYESIAN INTERACTIVE DECISION SUPPORT FOR MULTI-ATTRIBUTE PROBLEMS WITH EVEN SWAPS

(71) Applicant: INTERNATIONAL BUSINESS MACHINES CORPORATION, Armonk, NY (US)

(72) Inventors: Debarun Bhattacharjya, Ossining, NY (US); Jeffrey O. Kephart, Cortlandt Manor, NY (US)

(21) Appl. No.: 14/514,884

(22) Filed: Oct. 15, 2014

Related U.S. Application Data
(60) Provisional application No. 62/027,883, filed on Jul. 23, 2014.

(51) Int. Cl. G06N 7/00; G06N 5/04

(52) U.S. Cl. CPC G06N 7/005; G06N 5/045

(57) ABSTRACT

A system, method, and/or computer program product that provides a first table including a plurality of alternative choices, each alternative choice including a plurality of attributes, and analyzes the first table to identify a set of alternatives of the plurality of alternative choices. The analyzing includes identifying alternatives that are practically dominated in accordance with a probability distribution over user preferences. The system, method, and/or computer program product may also recommend an even swap based on the probability distribution over the user preferences. Next, an input is solicited by displaying the set of alternatives. In response to receiving the input responsive to the displaying, zero or more of the plurality of alternative choices are removed from the table.

### DOMESTIC PRIORITY

This application claims priority to U.S. Provisional Application No. 62/027,883, entitled “BAYESIAN INTERACTIVE DECISION SUPPORT FOR MULTI-ATTRIBUTE PROBLEMS WITH EVEN SWAPS,” filed Jul. 23, 2014, which is incorporated herein by reference in its entirety.

### BACKGROUND

The disclosure relates generally to a decision system that applies a Bayesian approach when guiding an even swaps process, and more specifically, to a decision system that makes queries based on a probability distribution pertaining to user preferences and updates the probability distribution as the even swaps process unfolds.

In general, in deterministic multi-attribute problems, a decision maker (DM) chooses among N alternatives, each of which has M attributes. As represented by equation 1, an alternative x is a vector of consequences for each attribute, where xᵢ is the consequence for attribute i:

x={xᵢ:i=1, . . . , M], (1)

This is often represented as a consequence table, which displays alternatives and attributes along its columns and rows respectively (e.g., consequence table 101 as illustrated by FIG. 1). When N and M are sufficiently large (e.g., in a range of 4 or more), the decision may become burdensome for a human decision maker. In such cases, it is desirable to create tools that assist the DM in identifying one or more alternatives that best reflect the DM's preferences.

One tool is to model the DM's preferences for the various attributes using a value function v(x). As represented by equation 2, an additive value function is one choice, mainly due to the ease with which the additive value function is elicited:

v(x)=Σᵢ₌₁^{M}wᵢvᵢ(xᵢ), (2)

where attribute weights w={wᵢ:i=1, . . . , M] are non-negative and sum to 1 and the vᵢ(xᵢ) represent one-dimensional marginal value functions. Note that a distinction is made between value and utility functions.

Further, there are several tools to elicit additive value functions, one of which involves direct elicitation (e.g., where the DM reveals preferred tradeoffs by answering questions pertaining to the weights and marginal value functions). Another tool is that of even swaps or even swaps method, which is an indirect preference elicitation that simultaneously solves a specific decision problem (e.g., using a decision support tool to provide method suggestions). With respect to the even swaps method, the DM answers a few simple and pointed queries to iteratively reduce the number of columns and rows in the consequence table until the optimal alternative is revealed. The difference between indirect preference elicitation, like even swaps method, and direct elicitation techniques is that the tool need not have a complete picture of the DM's preferences to find the optimal alternative for a particular decision. It is therefore often beneficial to use such techniques for reducing elicitation burden and potential inaccuracies.

However, with the above techniques, there is little the tools can do, aside from changing bounds midway through the method. Crucially, the tools are also unable to recognize swaps that are not feasible. Moreover, the tools do not cope well with any errors the DM may make in answering pairwise dominance queries.

### SUMMARY

According to one embodiment of the present invention, a method comprising providing, by a processor, a first table including a plurality of alternative choices, each alternative choice including a plurality of attributes; analyzing, by the processor, the first table to identify a set of alternatives of the plurality of alternative choices, the analyzing includes identifying alternatives that are practically dominated in accordance with a probability distribution; displaying, by the processor, the set of alternatives to solicit an input from a user; in response to the input, removing, by the processor, from the first table zero or more of the plurality of alternative choices to produce a second table of remaining choices.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 illustrates an example of a consequence table;

FIG. 2 illustrates an example of a computing node that implements a decision system;

FIG. 3 illustrates an example of an even swaps process with respect to a set of tables;

FIGS. 4 and 5 illustrate graphs with respect to a study comparing absolute and probable dominance;

FIGS. 6 and 7 illustrate process flows of a decision system; and

FIGS. 8-10 illustrate outputs by a decision system in graphical form.

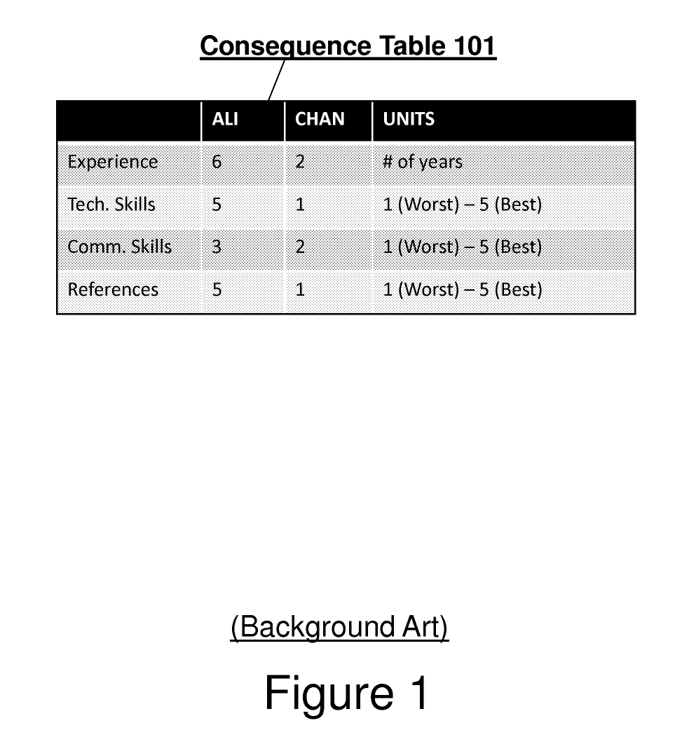

### DETAILED DESCRIPTION

In view of the above limitation of current tools, what is needed is a system and method that utilizes a Bayesian approach to guiding an even swaps process, whereby the system makes queries based on probability distributions (e.g., beliefs), about preferences (e.g., weights), of the decision maker (DM) and updates the probability distributions as the even swaps process unfolds.

In general, embodiments of the present invention disclosed herein may include a decision system, method, and/or computer program product that provides a first table including a plurality of alternative choices, each alternative choice including a plurality of attributes; analyzes the first table to identify a set of alternatives of the plurality of alternative choices, the analyzing includes identifying alternatives that are practically dominated in accordance with a probability distribution; displays the set of alternatives to solicit an input from a user; in response to the input, removes from the first table zero or more of the plurality of alternative choices to produce a second table of remaining choices.

The decision system, method, and/or computer program product further exploits prior information about a feasible weight region as represented by a prior probability distribution. The decision system, method, and/or computer program product, introduces the notion of probable dominance as well as a heuristic that recommends even swaps through probabilistic computations. The decision system, method, and/or computer program product also easily handles rejection of practical dominance queries, present new results about feasibility conditions for even swaps (using them to recognize and adapt to declarations of infeasible swaps), and is adept at providing inexperienced users with specific recommendations.

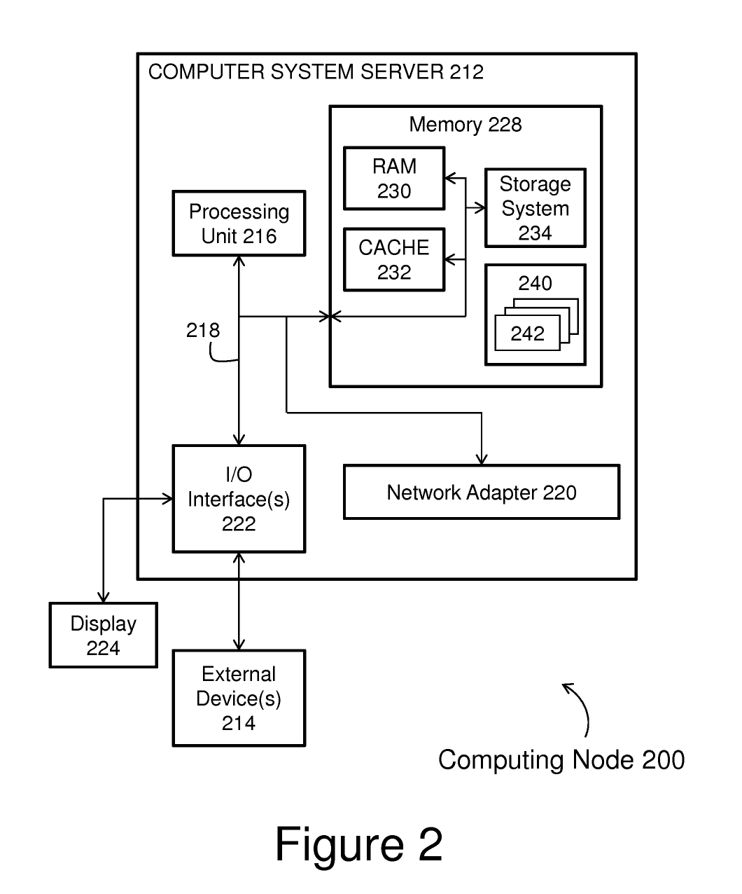

Systems and/or computing devices, such as the computing node 200 of FIG. 2 below, may employ any of a number of computer operating systems, including, but by no means limited to, versions and/or varieties of the AIX UNIX and z/OS operating system distributed by International Business Machines Corporation of Armonk, N.Y., the Microsoft Windows operating system, the Unix operating system (e.g., the Solaris operating system distributed by Oracle Corporation of Redwood Shores, Calif.), the Linux operating system, the Mac OS X and iOS operating systems distributed by Apple Inc. of Cupertino, Calif., the BlackBerry OS distributed by Research In Motion of Waterloo, Canada, and the Android operating system developed by the Open Handset Alliance. Examples of computing devices include, without limitation, a computer workstation, a server, a desktop, a notebook, a laptop, a network device, a handheld computer, or some other computing system and/or device.

In general, computing devices may include a processor (e.g., a processing unit 216 of FIG. 2) and a computer readable storage medium (e.g., a memory 228 of FIG. 2), where the processor receives computer readable program instructions, e.g., from the computer readable storage medium, and executes these instructions, thereby performing one or more processes, including one or more of the processes described herein (e.g., guiding an even swaps process with a Bayesian approach).

Computer readable program instructions may be compiled or interpreted from computer programs created using assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on a computing device, partly on the computing device, as a stand-alone software package, partly on a local computing device and partly on a remote computer device or entirely on the remote computer device. In the latter scenario, the remote computer may be connected to the local computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention. Computer readable program instructions described herein may also be downloaded to respective computing/processing devices from a computer readable storage medium or to an external computer or external storage device via a network (e.g., any combination of computing devices and connections that support communication). For example, a network may be the Internet, a local area network, a wide area network and/or a wireless network, comprise copper transmission cables, optical transmission fibers, wireless transmission, routers, firewalls, switches, gateway computers and/or edge servers, and utilize a plurality of communication technologies, such as radio technologies, cellular technologies, etc.

Computer readable storage mediums may be a tangible device that retains and stores instructions for use by an instruction execution device (e.g., a computing device as described above). A computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Thus, decision system and method and/or elements thereof may be implemented as computer readable program instructions on one or more computing devices, stored on computer readable storage medium associated therewith. A computer program product may comprise such computer readable program instructions stored on computer readable storage medium for carrying and/or causing a processor to carry out the operations of decision system and method.

The decision system, method, and/or computer program product may be implemented in, for example, a computing node. Referring now to FIG. 2, a schematic of an example of a computing node 200 is shown. The computing node 200 is only one example of a suitable computing node and is not intended to suggest any limitation as to the scope of use or operability of embodiments of the invention described herein. Regardless, the computing node 200 is capable of being implemented and/or performing any of the operability set forth hereinabove.

In the computing node 200 there is a computer system server 212, which is operational with numerous other general purpose or special purpose computing system environments or configurations. Examples of well-known computing systems, environments, and/or configurations that may be suitable for use with computer system server 212 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

The computer system server 212 may be described in the general context of computer system executable instructions, such as program modules, being executed by a computer system. Generally, program modules may include routines, programs, objects, components, logic, data structures, and so on that perform particular tasks or implement particular abstract data types. The computer system server 212 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 2, the computer system server 212 in the computing node 200 is shown in the form of a general-purpose computing device. The components of the computer system server 212 may include, but are not limited to, one or more processors or processing units 216, a system memory 228, and a bus 218 that couples various system components including the system memory 228 to the processing units 216.

The processing units 216 may include any processing hardware, software, or combination of hardware and software utilized by the computer system server 212 that carries out the computer readable program instructions by performing arithmetical, logical, and/or input/output operations. Examples of the processing units 216 include, but are not limited to an arithmetic logic unit, which performs arithmetic and logical operations; a control unit, which extracts, decodes, and executes instructions from a memory; and an array unit, which utilizes multiple parallel computing elements.

The bus 218 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

The computer system server 212 typically includes a variety of computer system readable media. Such media may be any available media that is accessible by the computer system server 212, and it includes both volatile and non-volatile media, removable and non-removable media.

The system memory 228 can include computer system readable media in the form of volatile memory, such as random access memory (RAM) 230 and/or cache memory 232. The computer system server 212 may further include other removable/non-removable, volatile/non-volatile computer system storage media. By way of example only, a storage system 234 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to the bus 218 by one or more data media interfaces. As will be further depicted and described below, the memory 228 may include at least one program product having a set (e.g., at least one) of program modules that are configured to carry out the operations of embodiments of the invention.

A program/utility 240, having a set (at least one) of program modules 242, may be stored in the memory 228 by way of example, and not limitation, as well as an operating system, one or more application programs, other program modules, and program data. Each of the operating system, one or more application programs, other program modules, and program data or some combination thereof, may include an implementation of a networking environment. The program modules 242 generally carry out the operations and/or methodologies of embodiments of the invention as described herein. For example, the program/utility 240 may be a decision application that includes instructions, that is stored on the memory 228, and/or that is executable by the processing unit 216 to cause the processing unit 216 to perform a guiding of an even swaps process with a Bayesian approach for a decision system.

The computer system server 212 may also communicate with one or more external devices 214 such as a keyboard, a pointing device, a display 224, etc.; one or more devices that enable a user to interact with the computer system server 212; and/or any devices (e.g., network card, modem, etc.) that enable the computer system server 212 to communicate with one or more other computing devices. Such communication can occur via input/output (I/O) interfaces 222.

The I/O interfaces 222 may include a physical and/or virtual mechanism utilized by the computer system server 212 to communicate between elements internal and/or external to the computer system server 212. That is, the I/O interfaces 222 may be configured to receive or send signals or data within or for the computer system server 212. An example of the I/O interfaces 222 may include a network adapter card or network interface configured to receive computer readable program instructions from a network and forward the computer readable program instructions, original records, or the like for storage in a computer readable storage medium (e.g., the memory 228) within the respective computing/processing device (e.g., the computer system server 212).

Still yet, the computer system server 212 can communicate with one or more networks such as a local area network (LAN), a general wide area network (WAN), and/or a public network (e.g., the Internet) via a network adapter 220. As depicted, the network adapter 220 communicates with the other components of the computer system server 212 via the bus 218. It should be understood that although not shown, other hardware and/or software components could be used in conjunction with the computer system server 212. Examples, include, but are not limited to: microcode, device drivers, redundant processing units, external disk drive arrays, RAID systems, tape drives, and data archival storage systems, etc.

The computing node 200 and elements therein may take many different forms and include multiple and/or alternate components and facilities. While the computing node 200 is shown in FIG. 2, the exemplary components illustrated in FIG. 2 are not intended to be limiting. Indeed, additional or alternative components and/or implementations may be used.

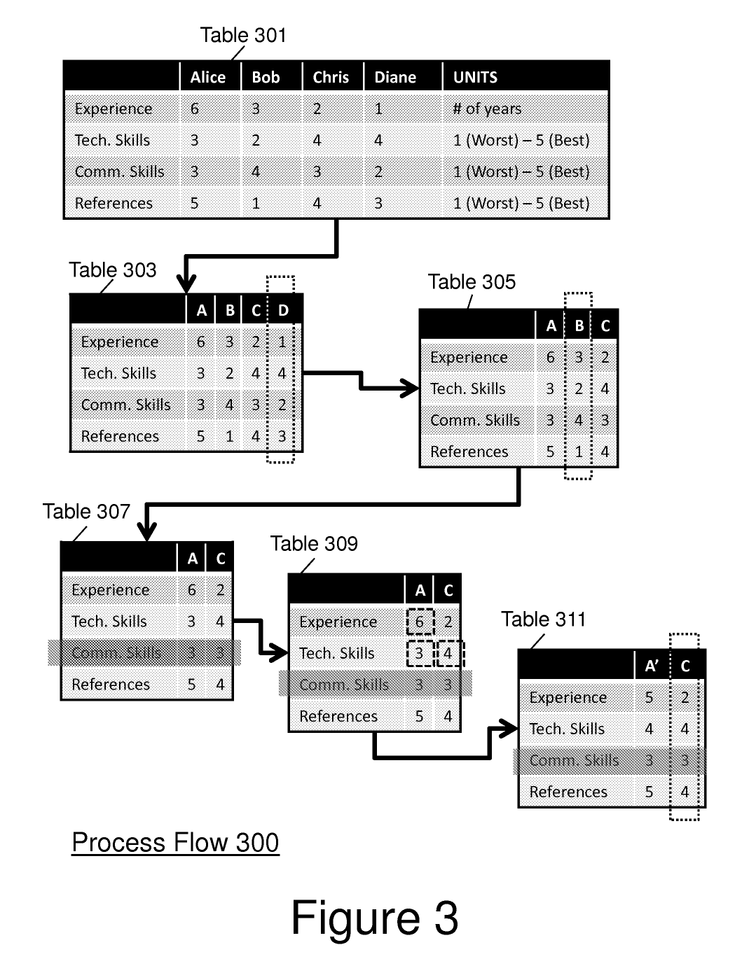

The decision system, method, and/or computer program product will be described with reference to FIGS. 3-10. The example illustrated in FIG. 3 is a hiring example of an even swaps process 300 with respect to a set of tables (e.g., Tables 301, 303, 305, 307, 309, 311), as presented by a decision application via a display 224. Note that the even swap process 300 receives its name from the even swap query, which assists in reducing the size (and therefore complexity) of the set of tables; and attempts to guide a DM (e.g., a manager) in simplifying a table (e.g., Table 301) so that a decision may be reached.

Before discussing FIG. 3, assumptions for a class of multi-attribute problems and results pertaining to properties of the even swaps process 300 will be discussed. That is, the decision application addresses the multi-attribute problems where the DM has an additive value function, e.g., of the form in equation (2), when attributes are mutually preferentially independent.

While the even swaps method is applicable in theory for all value functions and is not restricted to the additive form, the method can be challenging to apply when there is value dependence, in which case the DM would have to consider consequence levels of all attributes while making a judgment about an even swap. In that sense, no attribute would be ‘irrelevant’ when the DM makes the even swap based on their trade-offs. It is difficult to imagine the method being implemented successfully in such a situation without an analyst in the room to guide the DM. Therefore, the decision application provides an additive assumption that makes the decision system, method, and/or computer program product more likely to be used.

The decision application also assumes that one-dimensional marginal value functions are bounded, monotonic, and continuous. Since these functions are bounded, they are normalized such that 0≦vᵢ(xᵢ)≦1, vᵢ(xᵢ⁰)=0 and vᵢ(xᵢ*)=1 for all attributes, where xᵢ⁰ and xᵢ* represent the least and most preferred consequences for attribute i. The domain of an attribute is denoted Dᵢ, therefore for an attribute where more is preferred to less, Dᵢ=[xᵢ⁰,xᵢ*]. Monotonic attributes may assist the decision application in preserving order; non-monotonic attributes may be redefined by the decision application to render them monotonic. Furthermore, a discrete attribute may often be approximated by the decision application as continuous. For instance, in the hiring example discussed below, while three of the four attributes are measured as integers on a scale of 1 to 5, these same attributes may be approximated as continuous attributes.

As discussed above, the even swaps process 300 attempts to guide the DM by simplifying the table (e.g., Table 301). During this interactive process, the DM must carefully consider pairs of alternatives and their consequences along specific attributes. A consequence xᵢ is deemed to be preferred over yᵢ if it has higher marginal value, as expressed in equation (3).

xᵢ [symbol] yᵢ [symbol] vᵢ(xᵢ)>vᵢ(yᵢ), (3)

Any pair of alternatives x and y can therefore be associated with the following three sets of attributes: dominating set D(x,y)={i: xᵢ [symbol] yᵢ}, non-dominating set N(x,y)={i:xᵢ [symbol] yᵢ}, and equal set E(x,y)={i:xᵢ=yᵢ}. Note that D(x,y)=N(y,x).

The task with perhaps the lowest cognitive load for the DM and the lowest computational load for a system is identifying equal attributes. While somewhat more complex for a DM, it is also trivial for the decision application to discover absolute dominance, denoted x [symbol] ^{A}y, using non-dominating attribute sets of equation (4).

x [symbol] ^{A}y [symbol] N(x,y)=0, (4)

For a replicate pair of solutions, e.g., where both D(x,y)=0 and N(y,x)=0, either x or y may be removed from the table at random.

Practical dominance comes under consideration when one of the sets both D(x,y) and N(y,x) has many more elements than the other. While practical dominance claims help remove some solutions, the DM may eventually have to perform an even swap to manipulate the tables of the even swap process 300 to make further progress. Note that an even swap as s(xᵢ→x′ᵢ,xⱼ→x′ⱼ where the alternative x is modified by the DM, such that the change from xᵢ to x′ᵢ along attribute i is compensated by the change from xⱼ to x′ⱼ along attribute j. As noted below in the hiring example, the DM provided a response to a change from the score 3 to 4 on Technical Skills, along Experience. Further, the swap performed was specifically designed to make consequences identical for Technical Skills. This type of swap by the decision application is relatively cognitively comfortable for the DM, since they are able to observe the numbers along a specific row. Moreover, because the decision application ensures equal consequences, the table (e.g., Table 309) is simplified, which allows for potential ease of elicitation in future tasks. This type of a swap is referred to as an equalizing even swap. The equalizing even swap is defined as an even swap that makes the consequences of two alternatives equal along an attribute. That is, for any two alternatives x and y, s(xᵢ→yᵢ,xⱼ→x′ⱼ), is an equalizing even swap because it makes attribute i's consequences for both alternatives equal, thereby increasing the set E(x,y).

While an even swap may not always be possible, the following proposition provides the conditions under which an even swap is feasible, assuming that the DM's response is consistent with their value function. Proposition 1 (Even Swap Feasibility) states that:

$$the even swap s ( {x}_{i} \to {x}_{i}^{′} , {x}_{j} \to {x}_{j}^{′} ) , \\ i \neq j , {x}_{i} , {x}_{j}^{′} ∈ {D}_{i} is feasible only if \text{:}$$

$$( i ) When {x}_{i}^{′} ≻ {x}_{i} \text{:} {v}_{j} ( {x}_{j} ) \geq \frac{{w}_{i}}{{w}_{j}} [ {v}_{i} ( {x}_{i}^{′} ) - {v}_{i} ( {x}_{i} ) ]$$

$$( ii ) When {x}_{i}^{′} ≺ {x}_{i} \text{:} 1 - {v}_{j} ( {x}_{j} ) \geq \frac{{w}_{i}}{{w}_{j}} [ {v}_{i} ( {x}_{i}^{′} ) - {v}_{i} ( {x}_{i}^{′} ) ]$$

The Proof of Proposition 1 is that if x′ᵢ [symbol] xᵢ, the swap is not feasible when even a response of x′ⱼ=x⁰ᵢ cannot compensate for the change, which occurs when wⱼ[vⱼ(xⱼ)−vⱼ(x⁰ⱼ)]<wᵢ[vᵢ(xⁱᵢ)−vᵢ(xᵢ)]. The result follows after recognizing vⱼ(x⁰ⱼ)=0. Note that the other case is similar.

The fact that not all swaps are feasible is potentially problematic for the decision application attempting to guide the process by recommending equalizing even swaps. Since the decision application is not exactly aware of the DM's preferences during the process, it is possible for the decision application to propose a swap that is infeasible for the DM. Fortunately, as determined in the following proposition, if the s(xᵢ→yᵢ,xⱼ→x′ⱼ) is not feasible, its conjugate swap s(xⱼ→yⱼ,xᵢ→x′ᵢ) must be feasible. Proposition 1 (Equalizing Even Swap Feasibility) states that:

for any two alternatives x and y that do note dominate each other over attributes i and j, at least one of the equalizing even swaps s(xᵢ→yᵢ,xⱼ→x′ⱼ) or s(xⱼ→yⱼ,xᵢ→x′ᵢ) is feasible.
The Proof of Proposition 2 is as follows: suppose that yᵢ [symbol] xᵢ. If the swap the s(xᵢ→yᵢ,xⱼ→x′ⱼ) is not feasible, then from Proposition 1(i),

$${v}_{j} ( {x}_{j} ) \geq \frac{{w}_{i}}{{w}_{j}} [ {v}_{i} ( {y}_{i} ) - {v}_{i} ( {x}_{i} ) ] .$$

Rearranging, wᵢvᵢ(xᵢ)+wⱼvⱼ(xⱼ)<wᵢvᵢ(yᵢ). For the conjugate swap, by definition, wᵢvᵢ (xᵢ)+wⱼvⱼ(xⱼ)=wᵢvᵢ(x′ᵢ)+wⱼvⱼ(yⱼ). Using the condition from the infeasibility of the original swap, wᵢvᵢ(x′ᵢ)+wᵢvⱼ(yⱼ)<wᵢvᵢ(yᵢ) [symbol] wᵢvᵢ(x′ᵢ)<wⱼvⱼ(yⱼ) [symbol] x′ᵢ [symbol] yᵢ. The conjugate swap is therefore indeed feasible. The other case is similar.

The implication of these results is that a feasible swap can always be found by the decision application. That is, if the DM declares that a given even swap is infeasible, then the conjugate swap will be feasible and the decision application can recommend it. Note that both propositions assume that a DM's response is consistent with their value function. In the algorithm described in the next section, the decision application assumes the DM is willing to make either a swap or its conjugate, but noise in the response to an even swap query is incorporated.

In view of the above, the hiring example of FIG. 3 will now be described. As illustrated in FIG. 3, Table 301, a manager who faces a hiring decision and must choose among four candidates—Alice, Bob, Chris and Diane—across four attributes: Experience (in # of years) and qualitative measures such as Technical Skills, Communication Skills and References, each of which are scored on a scale of 1 (worst) to 5 (best). To pursue the even swaps process 300 to determine the optimal hire, the manager recognizes that Chris scores at least as well as Diane on all attributes and removes Diane from consideration, as seen in Table 303 with respect to the dotted-box around ‘Column D.’ This is an example of absolute dominance.

Next, in Table 305, the manager observes that Alice fares better on most attributes as compared to Bob, except for Technical Skills where Bob scores 1 point higher. Since Alice compensates for this deficit with the other attributes (e.g., Alice exhibits practical dominance over Bob), the manager removes Bob from consideration, as seen in Table 305 with respect to the dotted-box around ‘Column B.’

The manager then, in Table 307, notices that the remaining candidates, Alice and Chris, have the same score (3) on Communication Skills. The manager reasons that there does not need to be a concern with the Communication Skills attribute in subsequent iterations, as subsequent value judgments are conditional on this common score, and thus this attribute is greyed out in Table 307 (and subsequent tables). In the even swaps process 300, greying out an equivalent score may be referred to as a term equal attribute, as this attribute has become inactive.

Next, the manager observes that Alice fares worse on Technical Skills, but better on the remaining active attributes. As indicated by the three dashed-boxes in Table 309, the manager answers the following question: how many years of Experience would the manager be willing to give up for Alice to improve her Technical Skills score from 3 to 4? An even swap produces a hypothetical equivalent alternative in which a change in the consequences of one attribute balances the change in the consequences of another. The manager's response is determined by the manager's value judgments; in this case, the manager determines that Alice's Experience should give up 1 year by changing 6 years to 5 years and increasing the Technical Skills score to 4. In this way, the manager replaces Alice with a hypothetical clone (e.g., A′) in Table 311. Then, the manager recognizes that Alice absolutely dominates Chris (e.g., as indicated by the dotted-box around ‘Column C.’), thereby revealing Alice to be the optimal candidate.

The even swaps process 300 may be suitable for small problems where the interactive nature of the process 300, the access to the alternatives, and the (almost) instant gratification from solving the problem appeal to the DM. It is particularly useful for DMs who either find it difficult to answer questions about their trade-offs in terms of weight ratios, or who need to view/consider the alternatives to construct their preferences. However, the even swaps process 300 was originally intended to be self-guided. This was extended to a decision support system for guiding smart swaps, using preference programming (e.g., by recognizing a feasible region of weights for fixed bounds on marginal value functions). This decision support system makes the practical dominance notion precise by recommending it through pairwise dominance, which occurs when there is no way an alternative can be most preferred, based on the feasible weight region and bounds.

This decision support system, however, has several limitations. For instance, there is little the system can do if the system proposes a practical dominance query and the DM rejects it, aside from changing bounds midway through the process. Crucially, this decision support system is unable to recognize swaps that are not feasible. Moreover, it does not cope well with any errors the DM may make in answering pairwise dominance queries.

Thus, the decision system, method, and/or computer program product applies a Bayesian approach when guiding an even swaps process 300. That is, the decision application utilizes a Bayesian approach that exploits prior information about the feasible weight region as represented by a prior probability distribution and introduces the notion of probable dominance as well as a heuristic that recommends even swaps through probabilistic computations. The decision application also easily handles rejection of practical dominance queries, present new results about feasibility conditions for even swaps (using them to recognize and adapt to declarations of infeasible swaps), and is adept at providing inexperienced users with specific recommendations.

In guiding an interactive even swap, the decision application has prior beliefs p(w) about the DM's weights in their additive value function. If there is no a priori information available, the system may choose a uniform prior over the weight simplex: p(w)˜Dirichlet(∝) where a is a vector of 1 s. The decision application further knows the DM's marginal value functions, e.g., through prior assessments. Since these are one-dimensional functions, they are usually easier to elicit than weights that reflect trade-offs (as further described below, the decision application may be extended to the case of unknown marginal functions). In addition, the decision application may cope with uncertainty about the DM's weights by incorporating responses to recommended practical dominance and even swap queries from the DM. For instance, the decision application gradually learns the DM's preferences and exploits those preferences for the sole purpose of reaching the optimal alternative as soon as possible. The various aspects of the Bayesian approach will now be described.

One of the central notions of the original even swaps method is that of practical dominance, according to which an alternative can be discarded if it appears to be nearly absolutely dominated by another. The Bayesian approach by the decision application views practical dominance through a Bayesian lens, with the intent of reducing the cognitive burden of DMs.

With respect to absolute dominance, consider an alternative x whose consequences have been normalized; therefore it lies somewhere in the unit cube. x dominates a proportion of other alternatives given by the volume Πᵢ₌₁^{M} xᵢ, and is dominated by a proportion Πᵢ₌₁^{M} (1−xᵢ). Note that if a family of problems is built by generating alternatives uniformly over the consequence domains, then the probability that any particular alternative dominates another decreases exponentially with the number of attributes M. Therefore absolute dominance does not occur with sufficient frequency to be a basis for a practical decision support algorithm of the decision application. Moreover, in real-world settings, absolutely dominated alternatives would likely be shelved before reaching the conference room.

A relationship that is more useful is that of probable dominance, which measures the decision application's beliefs about whether the DM prefers an alternative to another. The probability that alternative x dominates y is denoted p_{xy}, as seen in equation (5):

p_{xy}=∫_{w}(Σᵢ₌₁^{M}wᵢ[vᵢ(xᵢ)−vᵢ(yᵢ)]≧0)p(w)dw: (5)

If the decision application believes that the DM is likely to prefer an alternative over another, the decision application may recommend them as a candidate pair for practical dominance. Although the DM makes the eventual judgment, the decision application recommends the pair to simplify the problem. Thus, the decision application may utilize a probable dominance above a certain threshold p_{T} to recognize potential practical dominance, p_{xy}≧p_{T}.

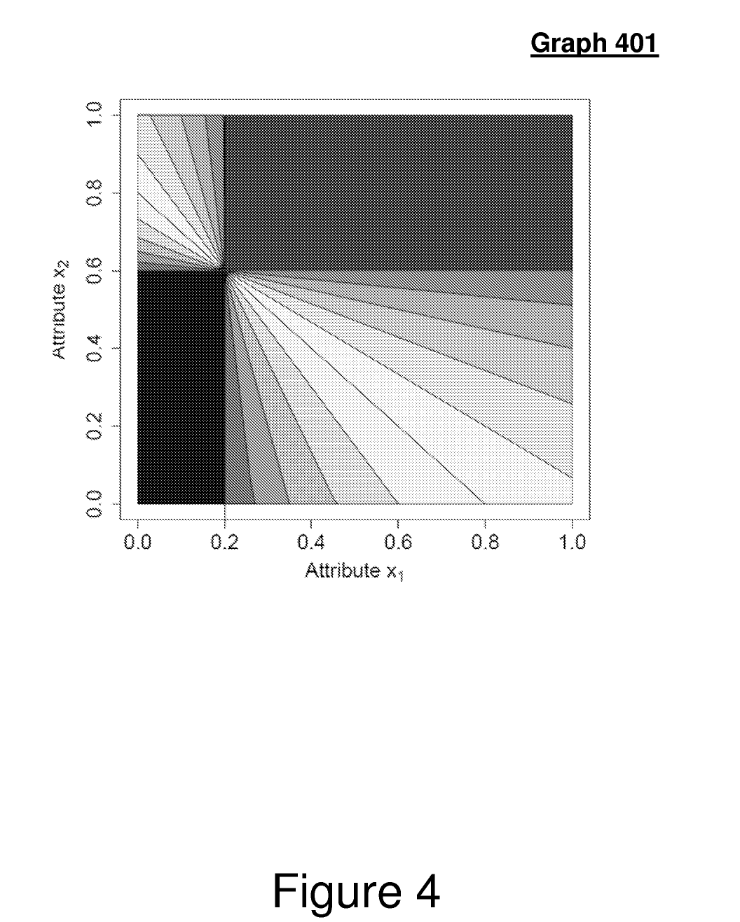

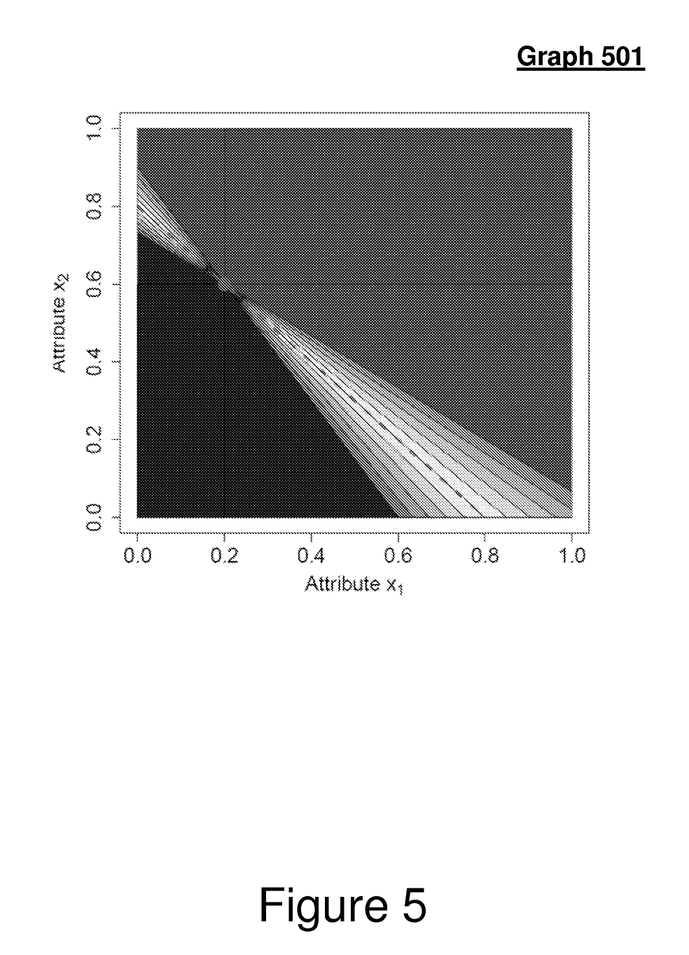

A Two-attribute Example will now be described, with reference to FIGS. 4-5, as a study comparing the occurrence of absolute and probable dominance. Suppose M=2 and that the DM's marginal value functions are linear and normalized to between 0 and 1. As a reference, suppose that the DM's trade-offs are accurately captured by weights w₁=0.5 and w₂=0.5.

FIG. 4 illustrates the regions of absolute and practical dominance with respect to a chosen alternative x=(0.2, 0.6), when the system believes that w₁˜Uniform(0,1). Alternatives that absolutely dominate x are shown in dark grey, while those that are absolutely dominated by x are shown in black. The regions of potential practical dominance (as determined by probable dominance) for various values of the probability p appear as bands of lighter grey, in increments of 0.1, ranging from p=0.9 to 10 (almost deep gray) down to p=0 to 0.1 (fully black).

FIG. 5 illustrates almost the same situation except now the decision application believes that w₁˜Uniform(0.4,0.6), e.g., by learning from responses to previous queries. It is immediately apparent that the reduced uncertainty yields enlarged regions in which there is a high certainty that x dominates or is dominated. These regions now appear as large triangles anking the rectangular regions of absolute dominance.

From a practical perspective, such regions are effectively equivalent to those of absolute dominance.

Relative to FIG. 4, the region of uncertainty is much more tightly clustered around the diagonal line x₁+x₂=0.8 that represents the boundary between x [symbol] y and x [symbol] x. This is due to the reduced uncertainty about the true value of w, and illustrates the benefits of reducing the uncertainty (e.g., enable the decision application to be more confident in suggesting potential practical dominance to the DM).

These examples illustrate that a pair of alternatives chosen at random is more likely to exhibit probable rather than absolute dominance, making it more useful in practice by the decision application. Further, numerical simulations performed by the decision application demonstrated that the probability for a given vector x to practically dominate a given vector y above a given threshold p_{T} is insensitive to the number of attributes M.

Algorithm 1 summarizes the decision application's approach to recommending practical dominance and updating beliefs:

Algorithm 1 Practical Dominance Query

Input: N alternatives, threshold p_{T}, prior p(w)
Initialize p_{D}^{max} = 0
for each pair of vectors x and y do

Compute p_{xy} from equation (5)
if p_{xy} ≧ max(p_{T}, p_{D}^{max}) then

Store pair x, y; p_{D}^{max} = p_{xy}

end if

end for
if p_{D}^{max} ≠ 0 then

Recommend potential practical dominance for x, y, inquiring

whether: x ≧ y

Update p(w)in accordance with DM's response, using equation (6)

else

There is no candidate pair

end if

Note that the decision application assumes that the DM responds accurately to queries based on their preferences, since the comparison question utilized by the decision application is typically associated with low cognitive load. Thus, a polytope of the weight region can be updated to incorporate a condition, as defined in equation 6, depending on whether the user responds ‘yes’ or ‘no’ to the question: do you prefer x over y?:

Σᵢ₌₁^{M}wᵢ[vᵢ(xᵢ)−vᵢ(yᵢ)]≧(≦)0, (6)

Note that recommending an effective even swap is more challenging than computing practical dominance. Further, as noted above, not all swaps are feasible. Thus, the notion of an equalizing even swap was introduced as a practical means of forming a simpler table. To make an equalizing even swap s(xᵢ→yᵢ,xⱼ→x′ⱼ), the decision application needs an alternative pair x,y and an attribute pair i,j. Moreover, the decision application is able to handle an infeasible swap.

Therefore, the decision application includes a heuristic for recommending an even swap that identifies the most suitable alternative and attribute pairs. In one breakdown, there are two processes involved. In the first process, the decision application identifies alternatives x,y where it believes x might be preferred over y. It is natural to use probable dominance to quantify this belief. In the second process, the decision application identifies attributes iεN(x,y) and jεD(x,y) such that swap s(xᵢ→yᵢ,xⱼ→x′ⱼ), is likely to decrease |N(x,y)|.

The intuition of the decision application behind the heuristic is that an even swap query potentially pushes a pair of alternatives towards dominance of some sort, making it eventually evident to both the decision application and the DM. Focusing on a pair where one is likely to dominate the other and reducing the non-dominated attribute set ensures that this occurs. As discussed above, an infeasible swap always possesses a feasible conjugate swap, so the heuristic is guaranteed to make progress (from a normative perspective). Note that the cognitive effort expended by the user in trying to respond to the original (failed) swap will be helpful in responding to its conjugate. Also, note also that the heuristic is myopic in that it attempts to find the ‘best’ swap at the current moment, without regard to long-term savings. Thus, this heuristic is viewed as a dominance-focused heuristic, as it tries to drive alternative pairs towards dominance.

In view of this heuristic, suppose that the decision system considers the equalizing even swap s(xᵢ→yᵢ,xⱼ→x′ⱼ). By definition, if equation 7 is feasible, e.g., it satisfies Proposition 1:

$${v}_{j} ( {x}_{j}^{i} ) = \frac{{w}_{i} ( {v}_{i} ( {x}_{i} ) - {v}_{i} ( {y}_{i} ) ) + {w}_{j} {v}_{j} ( {x}_{j} )}{{w}_{j}} , \qquad ( 7 )$$

Further suppose that i and j are both attributes where more is preferred to less. Then xᵢ is increased to yᵢ for the swap (because i E N(x,y)), therefore xⱼ is decreased to x′ⱼ if the swap is feasible. The probability that this swap will decrease the non-dominated set pₛ is defined by equation (8):

pₛ=P(x′ⱼ≧yᵢ)=P(vᵢ(x′ⱼ)≧vⱼ(yⱼ))=∫_{w}(Σ_{k=i,j}wₖ[vₖ(xₖ)−vₖ(yₖ)]≧0)p(w)dw, (8)

Note that the final step is a result of integration after rearranging (7). Note that pₛ is also a function of the swap; and, it should be inferred that it is associated with s(xᵢ→yᵢ,xⱼ→x′ⱼ). Also, note that although equation (8) applies only when i and j have monotonically increasing marginal value functions, it may be generalized it to include all other cases.

Algorithm 2 summarizes the decision application's approach to recommending even swaps and updating beliefs. Since an even swap is associated with a significant cognitive load, the decision application treats the response to lie within a noise band measured using the swap response noise δ. For instance, if a user responds to an even swap query with normalized consequence 0.6 and δ−0.2, then the system forms a lower bound L_{δ}=0.5 and upper bound U_{δ}=0.7. This noise band is subject to the other constraints posed on a response, i.e. it must lie within the domain. Therefore a response of 0.05 with δ−0.2 results in L_{δ}=0 and U_{δ}=0.15. If more of attribute j is preferred to less, the polytope of the weight region can be updated with conditions from two inequalities involving wᵢ and wⱼ, as seen in equation (9):

$${L}_{δ} \leq \frac{{x}_{j}^{′} - {x}_{j}^{0}}{{x}_{j}^{*} - {x}_{j}^{0}} \leq {U}_{δ} , \qquad ( 9 )$$

where L_{δ} and U_{δ} are bounds on normalized consequences (L_{δ}, U_{δ}ε[0,1]) that depend on the DM's response and δ as described above, and x′ⱼ is a function of the weights and marginal values as in equation (7). This equation may be modified for the case where less of attribute j is preferred.

Algorithm 2 Even Swap Query

Input: N alternatives, swap response noise δ, prior p(w)
Set threshold p_{T} = 0 and find alternative pair x, y from Algorithm 1
Initialize pₛ^{max} = 0
for each pair of attributes i in N(x, y) and j in D(x, y)do

Compute pₛ from equation (8)
if pₛ ≧ pₛ^{max} then

Store pair i, j; pₛ^{max} = pₛ

end if

end for
Recommend the swap s(xᵢ → yᵢ, xⱼ → x′ⱼ)
if Response is x′ⱼ then

Update p(w)with conditions from equation (9)

else if DM declares swap is infeasible then

Recommend conjugate swap s(xⱼ → yⱼ, xᵢ → x′ᵢ)
Update p(w)using equation (9), after swapping i and j

end if

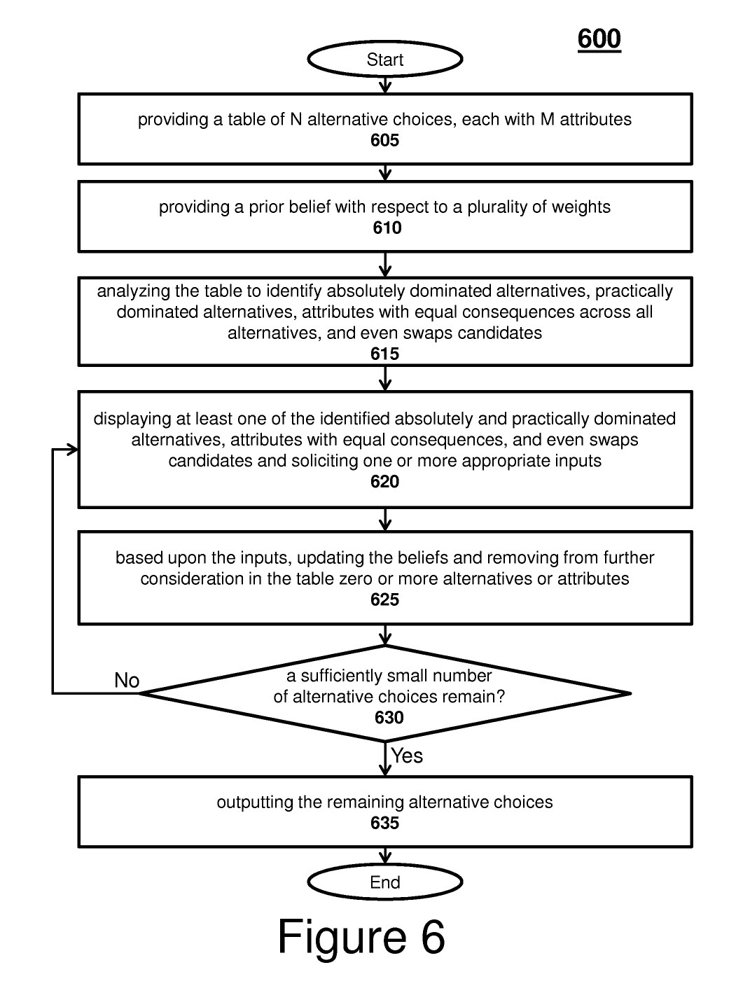

In view of the above Algorithms 1 and 2, the decision application performance of Algorithm 3 will now be described with references to FIGS. 6-10. Algorithm 3 provides the high-level routine for an interactive even swaps process by the decision application. The Algorithm 3 identifies absolute dominance and equal attributes, recommends practical dominance when it is confident enough, and recommends an equalizing even swap based on a dominance focused heuristic. The Algorithm 3 terminates when the optimal alternative is revealed.

Algorithm 3 Bayesian Smart Swaps

Input: N alternatives, threshold p_{T}, swap response noise δ, prior p(w)
while more than 1 solution and 1 active attribute
remain in table do

Remove absolutely dominated solutions, if any
Mark any attributes with equal consequences across alternatives as
inactive, if any
Identify potential practical dominance using Algorithm 1
if practical dominance detected then

Recommend it and update p(w) from response

else

Recommend an even swap using Algorithm 2 and update p(w)
from response

end if

end while
if single attribute remains then

Find the optimal alternative x

end if
Return x

FIG. 6 illustrates a process flow 600 performed by a decision application with respect to Algorithm 3. In block 605, the decision application provides a table of N alternative choices, each with M attributes. Returning to the hiring example above, a manager may face a hiring decision among four candidates, each of which have four attributes: Experience (in # of years) and qualitative measures such as Technical Skills, Communication Skills and References, each of which are scored on a scale of 1 (worst) to 5 (best).

Next, at block 610, the decision application provides a prior belief p(w) about the weights w. Note that a belief p(w), whether prior to or after a performing of the algorithms described herein, by the decision application is generally a probability solution (e.g., the decision system, method, and/or computer program product has a probability distribution over a user's weights, which represent their preference trade-offs over attributes). For example, if the manager has indicated in a prior decision that Experience (in # of years) has a higher weight than References, the decision application will issue as the probability solution the Experience attribute. Further, based on all prior decisions, the decision application will generate the probability distribution across the attributes, such that each of the manager's preferences is represented.

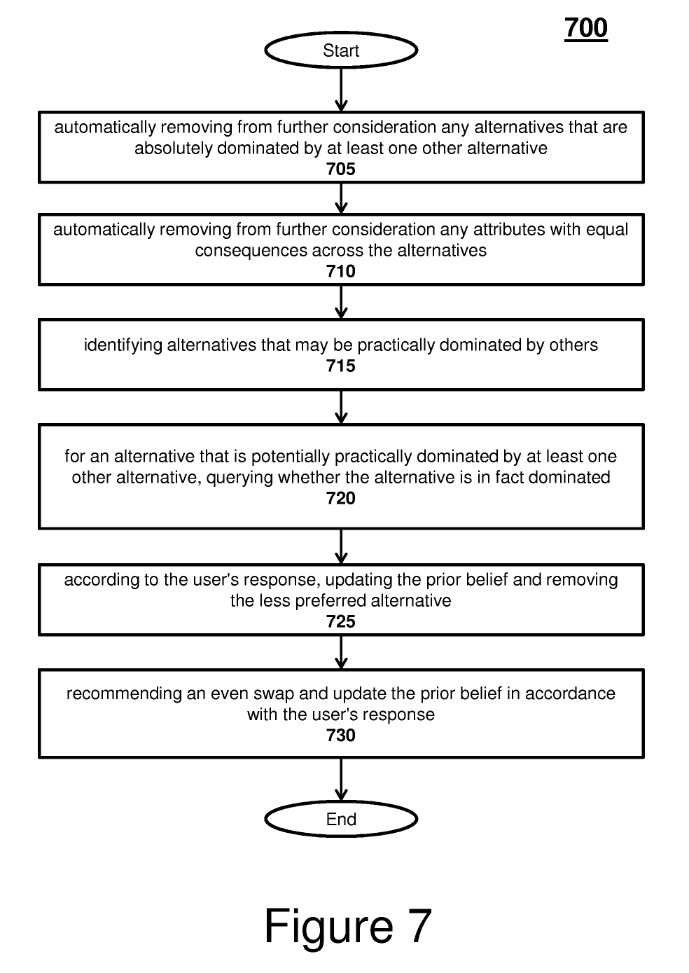

Then the process flow 600 proceeds to block 615, where the decision application analyzes the table to identify any absolutely dominated alternatives, practically dominated alternatives, attributes with equal consequences across all alternatives, and even swaps candidates. FIG. 7 illustrates a process flow 700 performed by a decision application particularly with respect to block 615 of FIG. 6. As illustrated in FIG. 7, the decision application in block 705 automatically removes from further consideration any alternatives that are absolutely dominated by at least one other alternative (e.g., see Table 303 of FIG. 3). Then, in block 710, the decision application automatically removes from further consideration any attributes with equal consequences across the alternatives (e.g., see Table 307 of FIG. 3).

In block 715, the decision application identifies alternatives that may be practically dominated by others (e.g., see Table 305 of FIG. 3). In this regard, the decision application utilizes the prior belief p(w) to recommend one alternative and/or attribute over another alternative and/or attribute. For instance, when the probability distribution indicates that Experience has a higher weight than other attributes, a first candidate with a higher value in Experience may practically dominate a second candidate who has a lower value in Experience and has higher values in the other attributes. Then the process flow 700 proceeds to block 720, where the decision application queries whether the identified practically dominated alternatives are in fact dominated (e.g., see Table 309 of FIG. 3). For example, for an alternative that is potentially practically dominated by at least one other alternative, a query is sent to the user to ask whether the alternative is in fact dominated. The query itself may further provide the recommended alternative and/or attribute. Next, in block 725, the decision application, according to the inputs (e.g., user response(s)) to the query, updates the prior belief p(w) and removes the less preferred alternative. Then the process flow 700 proceeds to block 730, where the decision application recommends an even swap and update the prior belief p(w) in accordance with the inputs. Then, the process flow 700 ends.

Next, at block 620, the decision application displays at least one of the identified absolutely and practically dominated alternatives, attributes with equal consequences, and even swaps candidates to a user (e.g., a decision maker or manager) and solicits one or more inputs and/or response(s). Then the process flow 600 proceeds to block 625, where the decision application, based upon the inputs and/or response(s), updated the beliefs p(w) and removes from further consideration in the table zero or more alternatives or attributes (e.g., as the decision system, method, and/or computer program product receives responses, the probability distribution is updated by the system, method, and/or computer program product).

Next, at decision block 630, the decision application determines whether a sufficiently small number of alternative choices remain. A sufficiently small number of alternative choice may be defined by the decision application as a remaining set of alternative choices being less than or equal to a specified amount of choices. If the decision application determines that there are not a sufficiently small number of alternative choices, the process flow 600 proceeds to block 620 so that a number of alternative choices may be reduced. If the decision application determines that there are a sufficiently small number of alternative choices, the process flow 600 proceeds to block 635. At block 635, the decision application outputs the remaining alternative choices, e.g., based also upon Algorithm 3. Then, the process flow 300 ends.

In Algorithm 3, the decision application assumes that it already knew the marginal value functions, perhaps through initial assessments. Subsequently, for all probabilistic computations (in this case those pertaining to computing probable dominance and the probability that the swap will decrease the non-dominated set) the decision application could use probability bounds for making recommendations and update its beliefs based on inequalities from these bounds.

Based on the above process flows 600, 700, a set of experiments were conducted to assess the degree to which learning reduces the number and complexity of queries directed to the DM. The Algorithm 3 was applied to a set of 100 randomly generated scenarios, each involving a randomly generated set of N alternatives with M attributes. Each of the NM values in the table was generated from a Uniform distribution (0,1). The user's true weights were drawn uniformly from the (M−1)-dimensional unit simplex, and the prior was the same uniform distribution over the simplex. For simplicity, the marginal value functions were assumed to be linear and ranging from 0 to 1.

For each scenario, the probability threshold for a probable dominance query was set relatively high (0.9) to ensure that the queries might not be too onerous for real humans to answer. The probability that x [symbol] y for the DM was computed by randomly generating at least 10000 weight vectors uniformly in the (M−1)-dimensional unit simplex. First, rejection sampling was employed, i.e. the randomly generated vectors were reduced to a set that satisfied any constraints introduced during the interactive process. Then the probable dominance probability was computed as the fraction of weight vectors for which x [symbol] y. Particularly in cases where several even swaps had been applied, the weights were pinned down so precisely that the number of samples satisfying the constraints dropped below 100, in which case more points were generated to ensure that the probable dominance probability was computed from reasonable statistics. To simulate the DM answering a probable dominance or even swaps query, the true weight vector was used to generate the response that the DM would have generated. The DM's noise about the swap value was modeled using a modest swap response noise of δ=0.2.

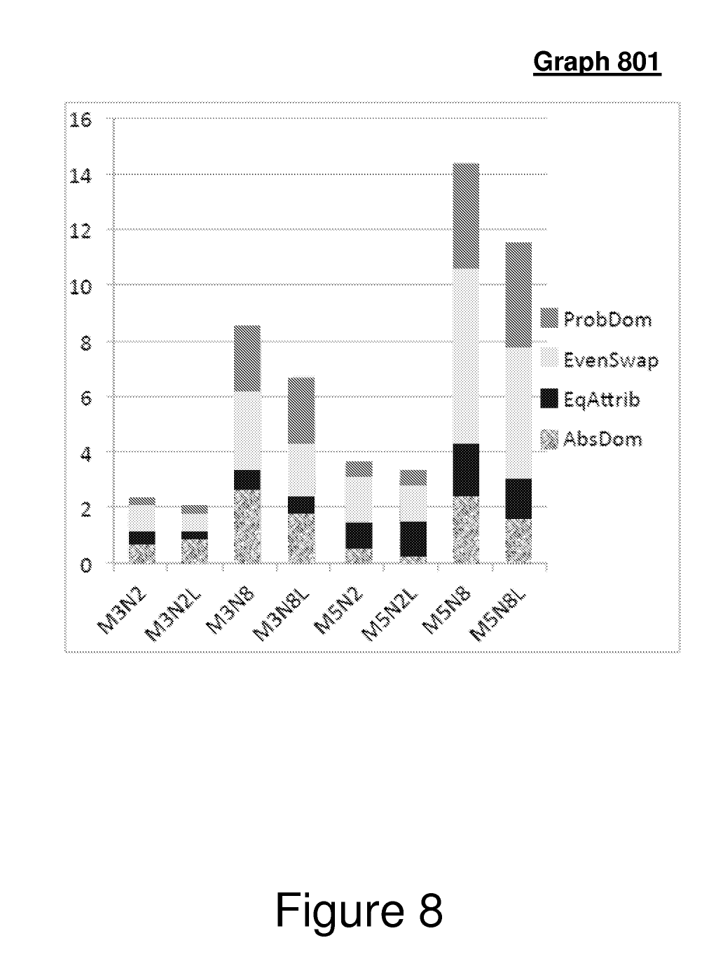

For each scenario, the number of absolute dominance and equal-attribute events (e.g., accomplished purely through system computations) were recorded. The number of probable dominance and even swap queries (e.g., including both regular and conjugate swaps) were recorded as well. These are queries that must be answered by the DM and therefore entail some cognitive burden. Eight sets of 100 scenarios were run, with the number of attributes set to M={3,5}, the number of solutions set to N={2,8}, and the method's learning element both turned on and turned off. The results are summarized in FIG. 8, illustrates the effect of learning upon the number and type of queries and events in graph 801. FIG. 8 illustrates the average number of absolute dominance and equal attribute events, as well as probable dominance and even swap queries per scenario, for M={3,5}×N={2,8}, with learning turned on (L) and off.

For the smallest scenarios ((M,N)=(3,2)), an average of just two queries and/or events is required, and typically there is one absolute dominance event and one even swap, with probable dominance and elimination by virtue of equal attributes playing a relatively minor role. Due to the small number of queries and/or events, learning has little impact. The average number of queries and/or events decreases from 2.33±0.11 to 1.96±0.11 a drop that is of marginal statistical significance. On the other hand, when the number of solutions is increased from 2 to 8, the average number of queries and/or events rises to 8.22±0.34 without learning and 6.7±0.23 with learning—a statistically significant decrease of 18%. When the number of attributes is increased from 3 to 5, a similar trend is observed. For N=2 solutions, the number of queries and/or events is 3.63±0.24 without learning and 3.35±0.24 with learning—an insignificant difference—whereas for N=8 solutions the number of queries and/or events is 14.37±0.57 and 11.51±0.41—a statistically significant drop of 20%.

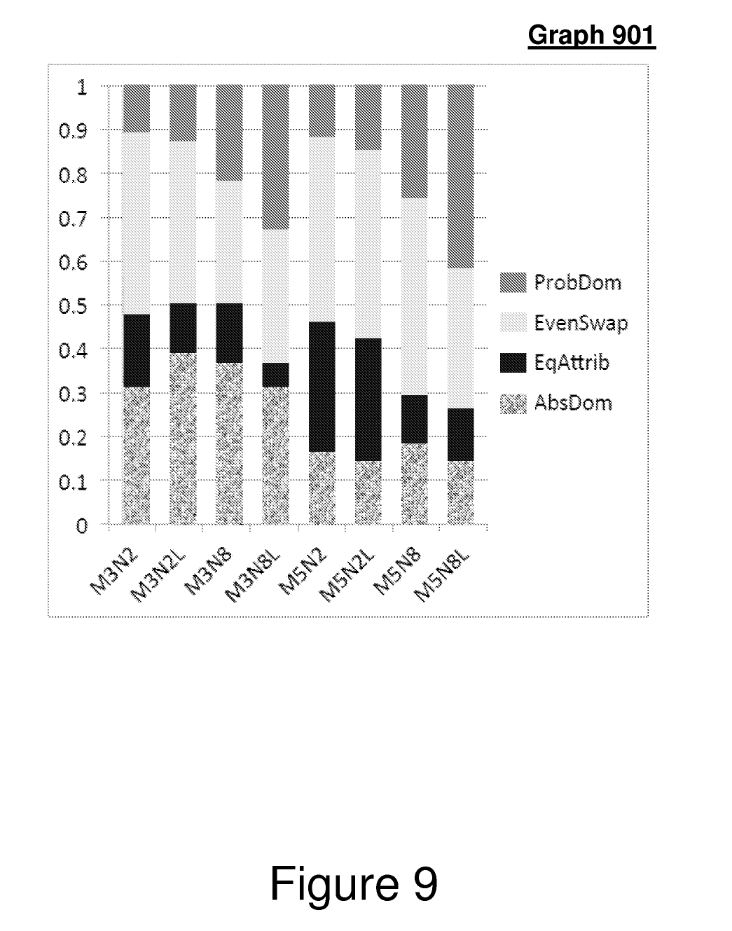

FIG. 9 provides another view of the same data as FIG. 8, except the graph 901 scales are normalized to 1 to illustrate the relative contributions of the different types of queries and events. Note that the impact of absolute dominance decreases as the number of solutions N increases from 2 to 8. This is a consequence of the exponential decrease in the probability for any given vector to absolutely dominate another with the number of attributes. Another trend evident here is that as N increases, the relative impact of probable dominance queries grows stronger. Moreover, for larger problems, the effect of learning is to further increase the relative importance of probable dominance over even swap queries.

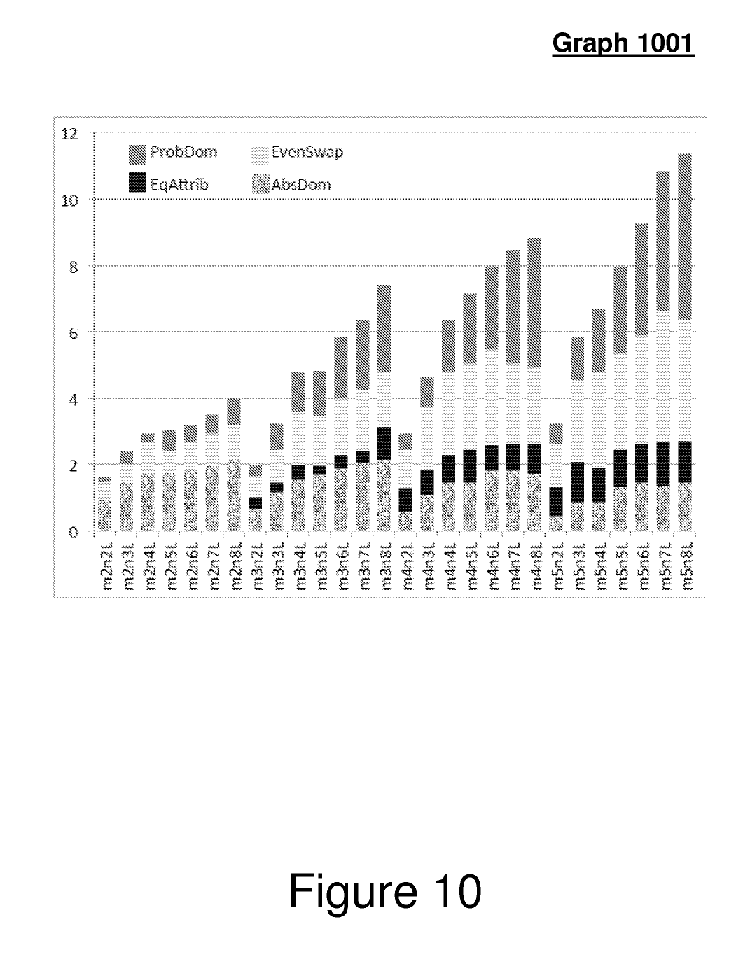

Having established that learning can substantially reduce the number of queries and/or events required to identify the optimal alternative, and moreover that it shifts the balance more from even swaps to probable dominance queries as the problem size grows, a second series of experiments were conducted with learning turned on. The objective of these experiments was to chart in greater detail how the number and type of queries and/or events change as the number of attributes and alternatives are varied. The results depicted in FIG. 10 demonstrate the same basic trends, including the waning importance of absolute dominance as the number of attributes M grows and the ascendancy of probable dominance as N grows. That is, FIG. 10 illustrates in graph 1001 the effect of M and N on the number and type of queries and events. Further, the average number of queries/events of each type, from left to right, for M={2, 3, 4, 5} and N={2, 3, 4, 5, 6, 7, 8}.

In view of the above, the decision system, method, and/or computer program product guides the DM through the even swaps process using an overall Bayesian approach with a dominance focused heuristic. It has also been demonstrated through experiments that the decision system, method, and/or computer program product can effectively learn about the DM's preferences in the course of a single session to guide the DM quickly to a final choice.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the operations/acts specified in the flowchart and/or block diagram block or blocks. These computer readable program instructions may also be stored in a computer readable storage medium that can direct a computer, a programmable data processing apparatus, and/or other devices to operate in a particular manner, such that the computer readable storage medium having instructions stored therein comprises an article of manufacture including instructions which implement aspects of the operation/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the operations/acts specified in the flowchart and/or block diagram block or blocks.

The flowchart and block diagrams in the Figures illustrate the architecture, operability, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical operation(s). In some alternative implementations, the operations noted in the block may occur out of the order noted in the figures. For example, two blocks shown in succession may, in fact, be executed substantially concurrently, or the blocks may sometimes be executed in the reverse order, depending upon the operability involved. It will also be noted that each block of the block diagrams and/or flowchart illustration, and combinations of blocks in the block diagrams and/or flowchart illustration, can be implemented by special purpose hardware-based systems that perform the specified operations or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

1-7. (canceled)

8. A computer program product, the computer program product comprising a computer readable storage medium having program instructions embodied therewith, the program instructions executable by a processor to cause the processor to:
provide a first table including a plurality of alternative choices, wherein each alternative choice includes a plurality of attributes;
analyze the first table to identify a set of alternatives of the plurality of alternative choices, wherein the analysis includes identifying alternatives that are practically dominated in accordance with a probability distribution over user preferences;
display the set of alternatives to solicit an input from a user; and
in response to the input, remove from the first table zero or more of the plurality of alternative choices to produce a second table of remaining choices.

9. The computer program product of claim 8, wherein the program instructions are further executable to cause the processor to:
generate the probability distribution over user preferences, wherein the probability distribution represents trade-offs over the plurality of attributes.

10. The computer program product of claim 9, wherein the program instructions are further executable to cause the processor to:
in response to the input, update the probability distribution in accordance with the input.

11. The computer program product of claim 8, wherein, with respect to the analysis of the first table to identify the set of alternatives, the program instructions are further executable to cause the processor to:
automatically remove any of the plurality of alternative choices that are absolutely dominated by at least one other alternative.

12. The computer program product of claim 8, wherein, with respect to the analysis of the first table to identify the set of alternatives, the program instructions are further executable to cause the processor to:
automatically remove or fix any of the plurality of attributes with equal consequences across the plurality of alternative choices.

13. The computer program product of claim 8, wherein, with respect to the identification of the alternatives that are practically dominated, the program instructions are further executable to cause the processor to further comprises:
identify potential choices from the plurality of alternatives choices that are potentially practically dominated; and
for each of the potential choices, determine by a query whether that potential choice is practically dominated.

14. The computer program product of claim 8, the program instructions are further executable to cause the processor to:
reduce a number of the remaining choices to a specified amount of choices by repeating the display of the set of alternatives to solicit the input from the user and the removal from the first table the zero or more of the plurality of alternative choices.

15. A system, comprising:
a memory having computer readable instructions; and
a processor for executing the computer readable instructions to cause the system to:
provide a first table including a plurality of alternative choices, wherein each alternative choice includes a plurality of attributes;
analyze the first table to identify a set of alternatives of the plurality of alternative choices, wherein the analysis includes identifying alternatives that are practically dominated in accordance with a probability distribution over user preferences;
display the set of alternatives to solicit an input from a user; and
in response to the input, remove from the first table zero or more of the plurality of alternative choices to produce a second table of remaining choices.

16. The system of claim 15, wherein the computer readable instructions further cause the system to:
generate the probability distribution over user preferences, wherein the probability distribution represents trade-offs over the plurality of attributes.

17. The system of claim 16, wherein the computer readable instructions further cause the system to:
in response to the input, update the probability distribution in accordance with the input.

18. The system of claim 15, wherein, with respect to the analysis of the first table to identify the set of alternatives, the computer readable instructions further cause the system to:
automatically remove or fix any of the plurality of alternative choices that are absolutely dominated by at least one other alternative.

19. The system of claim 15, wherein, with respect to the analysis of the first table to identify the set of alternatives, the computer readable instructions further cause the system to:
automatically remove any of the plurality of attributes with equal consequences across the plurality of alternative choices.

20. The system of claim 15, wherein, with respect to the identification of the alternatives that are practically dominated, the computer readable instructions further cause the system to:
identify potential choices from the plurality of alternatives choices that are potentially practically dominated; and
for each of the potential choices, determine by a query whether that potential choice is practically dominated.
